(19) United States
(12) Patent Application Publication
(10) Pub. No.: US 2004/0066830 A1
(43) Pub. Date: Apr. 8, 2004

(54) Electrode and method for arranging the electrode in electric arc furnaces

(76) Inventors: Roland Konig, Duisburg (DE); Walter Weischedel, Meerbusch (DE)

Correspondence Address: Friedrich Kueffner, Suite 910, 317 Madison Avenue, New York, NY, 10017, US

(21) Appl. No.: 10/640,473

(22) Filed: Aug. 13, 2003

(30) Foreign Application Priority Data
Aug. 17, 2002 (DE) 102 37 759.6

(51) Int. Cl. H05B 7/18

(52) U.S. Cl. 373/60

(57) ABSTRACT

An electrode for electric arc furnaces, in which metallurgical processes are performed, has a current-conducting electrode core having a core end pointing in a direction of the furnace bottom in the mounted state of the electrode. An electrode armor made of an electrically conducting material is provided that is process-neutral relative to a molten mass and slag of the metallurgical processes. The electrode armor is arranged on the electrode core and the core end such that at least the electrode portion immersed into the slag or the molten mass is completely enclosed. In this way, contact between the electrode and the slag and molten mass is prevented.

### BACKGROUND OF THE INVENTION

1. Field of the Invention

The invention relates to an electrode for electric arc furnaces in which metallurgical processes, such as melting and/or other processing steps are performed. The electrode comprises a current-carrying electrode core. Moreover, the invention relates to a method of arranging the current-carrying electrode in an electric arc furnace, in particular, an electric arc reduction furnace comprising a lower furnace part for receiving the molten mass and an upper furnace part, wherein the electrode is inserted through an opening in the upper furnace part and extends into the interior of the furnace.

2. Description of the Related Art

As is known in the art, the energy required for the metallurgical processes carried out in electric arc furnaces is introduced as electrical energy via electrodes. Electric arc furnaces are, for example, used in recycling processes, in particular, for melting scrap steel. In some known methods the electrodes are immersed into the molten mass being formed in the process or into the molten mass which has been introduced for processing. Conventionally, carbon or graphite electrodes are used for transmitting the current.

DE 36 03 948 A1 discloses an electric arc reduction furnace. In order to prevent that the electrodes are exposed to the aggressive atmosphere of the furnace interior in the free furnace space between the furnace cover and the slag bath and to prevent that the aggressive furnace atmosphere can lead to a massive radial erosion of the electrodes, it is disclosed in this document to provide protective shields within the furnace which project parallel and at a spacing to the electrodes into the interior of the furnace and shield the electrodes from the oxygen-containing and dust-containing atmosphere.

Also, electrodes with an electrode core are known which core, for prevention of oxidation by the furnace atmosphere, is provided with a very thin protective layer across its peripheral surface. Such protective layers serve only as an oxidation protection means and do not withstand chemically extremely aggressive molten masses, for example, specialty molten masses flushed with chlorine. On the other hand, electrode material contamination of the molten mass is undesirable for certain specialty molten masses.

### SUMMARY OF THE INVENTION

It is an object of the present invention to configure an electrode such that it can be used also in combination with chemically extremely aggressive molten masses or in molten masses which would be compromised by carbon from the electrode.

In accordance with the present invention, this is achieved in regard to the electrode in that the electrode core including the electrode core end (or electrode core tip) pointing in the direction of the furnace bottom is provided with an electrode armor of an electrically conducting material which, with regard to the molten mass and the slag, is process-neutral, and wherein the electrode armor completely encloses at least the electrode portion which is in contact with the slag or the molten mass and, in this way, prevents contact of the electrode core with the slag/molten mass.

The armor behaves process-neutral relative to the molten mass and/or the slag or the metal to be molten that is not yet melted over the entire processing duration, i.e., it does not interact in any way during the process being performed in the furnace. As a result of this property and because the bottom portion of the electrode is entirely sealed relative to the molten mass bath, the electrode also cannot be attacked by chemically aggressive media. Moreover, carbon from the electrode cannot escape and contaminate the molten mass bath. Overall, an electrode which is essentially, or completely, wear-resistant is provided so that, if desired, an adjusting device for the electrode is not needed. Moreover, this electrode can also be used in connection with molten masses which should not come into contact with carbon.

The electrode armor can be arranged like a protective cap on the electrode core; preferably, the process-neutral armor extends also across the electrode portion which is exposed to the furnace atmosphere. The electrode armor is then a complete enclosure of the peripheral surface and the bottom part of the electrode core and protects the electrode core over its entire length.

According to a first embodiment, the armor is applied directly onto the electrode core, for example, in that the armor material is applied by spraying. In such a case, the armor material should have a thermal expansion coefficient which matches substantially that of the material of the electrode core in order to prevent temperature differences of the electrode during its use and the resulting internal stress and to prevent that the armor layer would chip off the electrode core.

According to a particularly preferred embodiment, the armor is formed as a separate cup-shaped receptacle for the electrode core into which the electrode core can be inserted. In this way, a strong and tight armor for the electrode core is provided. This can be achieved in several ways. Firstly, the armor can be attached separately on the electric arc furnace and, subsequently, the electrode core can be moved into the cup-shaped receptacle. Secondly, the armor and the electrode core can be combined outside of the furnace, preferably in the vicinity of the furnace, and can be introduced subsequently as a unit into the furnace. In this connection, the electrode core and the armor can form a unit of detachably combined parts, for example, by being connected by a bolt connection; they can also be connected to one another by press-fit, if needed, in a non-detachable way. For a press fit connection it is recommended that the electrode core and the cup-shaped receptacle are conically shaped in order to press the electrode core with a tight press fit into the cup.

Preferably, the armor is comprised of a technical ceramic material with excellent electrical conductivity. For example, SiSiC (silicon-infiltrated silicon carbide) or mixed ceramic materials on the basis of Al₂O₃, TiC or TiN can be employed. Also, technical ceramic materials are known which, at approximately 1000° C., have an electrical resistance that is only 1% of the resistance value at room temperature.

As an alternative to a technical ceramic material, the use of synthetic, heat-resistant and electrically conducting materials is also possible.

The thickness of the armor depends on the dimensions of the electrode and the required output. For mechanical reasons, the thickness should not be below approximately 2 mm.

In order to be able to compensate different thermal expansion behavior of the material of the electrode core and of the armor material, between the electrode core and the armor an electrically conducting buffer medium should be arranged. As a function of the immersion depth of the electrode into the molten mass bath, the electrode core and the armor will expand differently across their length as a result of the heat introduction. The intermediate medium or buffer medium should be configured such that it can compensate fluctuating distances between the electrode core and the armor or can fill different volumes/shapes.

Preferably, between the electrode core and the armor an intermediate space remains which is filled with such an electrically conducting medium. The medium is preferably flowable for this purpose, for example, it is in the broadest sense a granular material e.g. in the form of a powder or comprised of spherical particles. Examples of such small-grain materials are graphite or metal cuttings. Also, liquids can be directly filled as an intermediate medium into the intermediate space. It is also advantageous to introduce into the intermediate space a metallic textile material or woven metal material which forms a current connection between the core in the armor and functions as a buffer layer.

In as much as the medium is not introduced in the liquid state into the gap, it is recommended to provide in the intermediate space a heating element, preferably, an SiC heating element. Solid small-grain flowable material with a low melting point is transferred, shortly before or at the beginning of processing, into the liquid state by introducing heat energy so that no hollow spaces remain in the intermediate space which would impede current flow.

By means of the separate armor and/or the buffer medium, different thermal expansion behavior is compensated and the thickness of the armor is not limited to certain values.

The electrode, aside form having an electrode core of carbon, in particular, graphite, can also have an electrode core of metallic material. This is recommended, in particular, in the case of molten masses which should not be mixed with carbon. In the case of an electrode core made of a metallic material, the electrode core should have cooling channels through which a liquid or gaseous medium flows for cooling purposes. This results in a permanent electrode core. This has the additional advantage that the armor is cooled indirectly and, in this way, wear of the armor is minimized.

The electrode according to the invention can be used in all types of arc furnaces. They can be used with three-phase furnaces as well as direct current furnaces. Preferably, such electrodes are to be used in electric arc reduction furnaces whose applications can thus be expanded to chemical-physical specialty melting processes. They can be used, in particular, also in connection with molten masses which are chemically very aggressive.

In accordance with the present invention, the aforementioned object is achieved in regard to the method in that the electrode core is introduced into a separate electrode armor comprised of an electrically conducting material which is process-neutral relative to the molten mass and/or the slag and encloses the electrode core including the electrode core end pointing in the direction of the furnace bottom and, in this way, prevents contact of the electrode with the slag or the molten mass.

Further details and advantages of the invention result from the dependent claims and the following description in which the embodiments illustrated in the drawing as well as the method will be explained in more detail.

### BRIEF DESCRIPTION OF THE DRAWING

In the drawing:

FIG. 1 shows schematically a sectional view of a melting furnace with two electrodes of different embodiments;

FIG. 2 shows schematically a sectional view of an electrode core with armor supplied or sprayed directly onto the electrode;

FIG. 3 shows schematically a sectional view of a unit of electrode core and armor connected by press fit.

### DESCRIPTION OF THE PREFERRED EMBODIMENTS

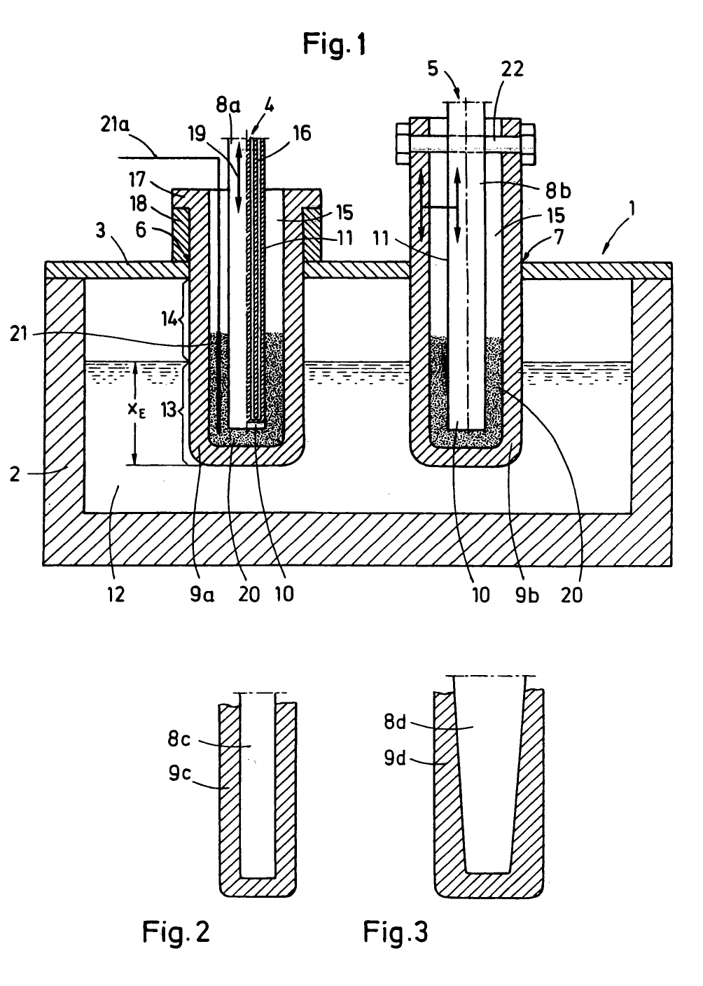

FIG. 1 shows an electric arc furnace 1, for example, an arc reduction furnace, comprising a lower furnace part 2 and an upper furnace part 3 in the form of a cover in which two current-conducting electrodes 4, 5 are introduced. The furnace 1 itself is provided with a refractory lining and/or cooling elements (not illustrated) such as cooling bodies through which water flows. When a closed furnace configuration is required for the respective metallurgical melting and/or processing step, the electrodes 4, 5 are gas-tightly introduced through openings 6, 7 in the cover; this is illustrated in the drawing.

The electrodes 4, 5 have in common that they have an electrode core 8a, 8b as well as an electrode armor 9a, 9b surrounding the end 10 or tip of the peripheral surface 11 of the electrode core 8a, 8b. The electrode armor 9a, 9b has the task of preventing chemical-physical reactions between the electrode cores 8a, 8b and the molten bath 12. The armor 9a, 9b extends across the electrode portion 13 to be immersed into the molten bath 12 as well as across the electrode portion 14 which is exposed to the furnace atmosphere.

The electrodes 4, 5 illustrated in FIG. 1 are units in which the electrode cores 8a, 8b are introduced into armors 9a, 9b embodied as separate cup-shaped receptacles so that an intermediate space 15 remains between the core and the armor. The left electrode 4 according to FIG. 1 is comprised of a metallic electrode core 8a having vertically extending cooling channels 16 integrated therein which are supplied with cooling medium from a cooling system (not illustrated. The media, for example water, flowing therethrough cool the electrode core 8a and thus also the armor 9a.

The armor 9a itself is a cup-shaped receptacle and comprised of a technical ceramic material. The armor 9a can also be referred to as a pipe closed at the bottom or a sleeve that is closed at the bottom. This cup is suspended by means of a collar 17 on suitable supports 18 or posts from the furnace cover or the furnace building. It projects down into the molten bath 12.

For introducing electric current, subsequently the electrode core 8a is introduced from above vertically (see arrow 19) into the interior of the receptacle. It is recommended to introduce already in a prior step flowable medium 20 or material of a low melting point into the lower part of the receptacle. Once the electrode core 8a has been positioned, additional material 20 is filled into the intermediate space 15 or gap formed between the outer wall of the electrode core 8a and the inner wall of the receptacle. In addition, in the intermediate space 15 a heating element 21, for example, an SiC heating conductor, is vertically arranged which is supplied by line 21a from the exterior with energy. This heating element 21 is provided to melt the solid material 20 in the intermediate space 15 and, in this way, provide optimal conditions for current flow from the electrode core 8a through the medium and the outer armor 9a. Moreover, the intermediate material serves as a buffer or compensation element with respect to different thermal expansion behavior of the electrode core and the armor. After completion of the process and cooling of the furnace, this medium will solidify again. For preventing stress upon solidification of the medium, a conical configuration of the electrode core or at least of the inner side of the armor can be provided. Because the electrode core does not come into contact with the molten mass, it is hardly subjected to wear.

Because of the stationarily arranged cup, the described electrode b is not adjustable with regard to immersion depth X_{E} into the molten bath 12. The electrode 5 illustrated to the right of FIG. 1 shows an embodiment which is variable or adjustable with respect to its immersion depth. For this purpose, the electrode core 8b—in the illustrated embodiment a carbon or graphite electrode—is introduced into the separate cup-shaped receptacle of the armor 9b, especially outside of the furnace 1, and the electrode core 8b as well as the upper part of the receptacle or of the armor 9b are then detachably connected by means of a common bolt 22. The resulting intermediate space 15, in the same way as described in the left electrode, is filled with conductive material 20 and the electrode is introduced into the furnace 1 as a unit.

According to the third embodiment, illustrated in FIG. 2, the armor 9c is a protective shield applied directly on the electrode core 8c. In this way, a direct electrical contact between armor and electrode core is provided. Electrode core 8c and armor 9c are a unit of non-detachable components which can be moved together in and out of the furnace. The same holds true for the embodiment according to FIG. 3 in which the electrode core 8d has a conical shape and is press-fit into an armor 9d; this results in excellent current flow between the two parts results. The armor 9d can also be conically shaped. It is possible in this embodiment to provide also an electrically conducting intermediate layer.

While specific embodiments of the invention have been shown and described in detail to illustrate the inventive principles, it will be understood that the invention may be embodied otherwise without departing from such principles.

What is claimed is:

1. An electrode for an electric arc furnace, in which metallurgical processes are performed, the electrode comprising:
a current-conducting electrode core having a core end pointing in a direction of a furnace bottom of the electric arc furnace in a mounted state of the electrode;
an electrode armor comprised of an electrically conducting material that is process-neutral relative to molten mass and slag of the metallurgical processes;
wherein the electrode armor is arranged on the electrode core and the core end such that at least an electrode portion immersed into the slag or the molten mass is completely enclosed.

2. The electrode according to claim 1, wherein the electrode armor extends across an electrode portion exposed to a furnace atmosphere of the electric arc furnace.

3. The electrode according to claim 1, wherein the electrode armor is formed as a separate cup-shaped receptacle for the electrode core and wherein the electrode core is inserted into the receptacle.

4. The electrode according to claim 1, wherein the cup-shaped receptacle and the inserted electrode core are detachably connected.

5. The electrode according to claim 1, wherein an outer size of the electrode core and an inner size of the cup-shaped receptacle are selected relative to one another such that the electrode core is mounted with press-fit in the receptacle.

6. The electrode according to claim 5, wherein the electrode core and the receptacle have a complementary conical shape.

7. The electrode according to claim 1, further comprising an electrically conducting medium arranged between the electrode core and the electrode armor.

8. The electrode according to claim 7, wherein the electrically conducting medium has excellent heat-conducting properties.

9. The electrode according to claim 7, wherein between the electrode core and the electrode armor an intermediate space is formed and filled which the electrically conducting medium.

10. The electrode according to claim 7, wherein the medium for filling the intermediate space is flowable and is a powder, is comprised of spherical particles, or is a liquid.

11. The electrode according to claim 10, further comprising a heating element arranged in the intermediate space for converting the medium in the intermediate space from a solid state to a liquid state.

12. The electrode according to claim 7, wherein the medium for filling the intermediate space is a woven metal material.

13. The electrode according to claim 1, wherein the electrode armor is directly applied to the electrode core.

14. The electrode according to claim 1, wherein the electrode armor is comprised of an electrically conducting ceramic material or a synthetic, heat-resistant, and electrically conducting material.

15. The electrode according to claim 1, wherein the electrode core is comprised of a metallic material or of carbon.

16. The electrode according to claim 15, wherein the carbon is graphite.

17. The electrode according to claim 15, wherein the electrode core has cooling channels configured to guide a cooling liquid or a cooling gas through the electrode core.

18. The electrode according to claim 17, wherein the electrode core is comprised of a metallic material.

19. A method for arranging a current-conducting electrode in an electric arc furnace, wherein the electric arc furnace comprises the lower furnace part for receiving the molten mass and upper furnace part, wherein the electrode is inserted through an opening of the upper furnace part and extends into an interior of the electric arc furnace, the method comprising the step of:
providing a separate electrode armor comprised of an electrically conducting material and being process-neutral relative to molten mass and slag in the electric arc furnace; and
inserting an electrode core of the electrode into the separate electrode armor such that the electrode armor encloses the electrode core including an electrode core end, oriented in a direction toward a furnace bottom of the electric arc furnace in a mounted state of the electrode, to prevent contact of the electrode with the slag and the molten mass.

20. The method according to claim 19, further comprising, before the step of inserting, the steps of arranging the separate electrode armor stationarily in the upper furnace part and detachably securing the electrode core in the separate electrode armor after the step of inserting so that the electrode core is removable from the separate electrode armor as needed.

21. The method according to claim 19, further comprising, after the step of inserting, the steps of detachably securing the electrode core in the separate electrode armor to form a unit and subsequently positioning the unit inside the electric arc furnace.

22. The method according to claim 19, further comprising the step of filling an intermediate space, remaining between an outer wall of the electrode core and an inner wall of the separate electrode armor, with an electrically conducting medium.
